(19) United States
(12) Patent Application Publication
(10) Pub. No.: US 2014/0118516 A1
(43) Pub. Date: May 1, 2014

(54) SOLID STATE IMAGING MODULE, SOLID STATE IMAGING DEVICE, AND INFORMATION PROCESSING DEVICE

(71) Applicant: KABUSHIKI KAISHA TOSHIBA, Tokyo (JP)

(72) Inventors: Kazuhiro SUZUKI, Tokyo (JP); Risako Ueno, Tokyo (JP); Mitsuyoshi Kobayashi, Tokyo (JP); Honam Kwon, Kawasaki-Shi (JP); Hideyuki Funaki, Tokyo (JP)

(73) Assignee: KABUSHIKI KAISHA TOSHIBA, Tokyo (JP)

(21) Appl. No.: 13/827,237

(22) Filed: Mar. 14, 2013

(30) Foreign Application Priority Data
Oct. 30, 2012 (JP) 2012-238720

(51) Int. Cl. H04N 5/225

(52) U.S. Cl. CPC H04N 5/2253
USPC 348/65; 348/374; 348/143; 348/207.1

(57) ABSTRACT

A solid state imaging module according to an embodiment can be attached to and detached from an information processing device, the solid state imaging module including: an imaging element formed on a semiconductor substrate and including a plurality of pixel blocks, each of the plurality of pixel blocks having a plurality of pixels; a first optical system for imaging a subject on an imaging plane; and input and output terminals that are connectable to the information processing device, which processes information from the imaging element.

### CROSS REFERENCE TO RELATED APPLICATIONS

This application is based upon and claims the benefit of priority from prior Japanese Patent Application No. 2012-238720 filed on Oct. 30, 2012 in Japan, the entire contents of which are incorporated herein by reference.

### FIELD

Embodiments described herein relate generally to solid state imaging modules, solid state imaging devices, and information processing devices.

### BACKGROUND

Various techniques such as a technique using reference light and a stereo ranging technique using two or more cameras have been suggested as imaging techniques for obtaining two-dimensional array information about the distances to objects in the depth direction. In particular, recently, needs have grown for relatively inexpensive products as new input devices to be used in consumer appliances. In an imaging device using light field photography technology, a function is required for switching between a general imaging mode with high definition, in which the light field photography technology is not used, and an imaging mode based on the light field photography technology. In the former imaging mode, no microlens is required, and in the latter imaging mode, it is necessary that microlenses are arranged on an optical axis.

A conventional camera requires an element driving mechanism to switch between the two imaging modes. The employment of such an element driving mechanism would increase the costs. In addition, such an element driving mechanism is not very reliable.

### BRIEF DESCRIPTION OF THE DRAWINGS

FIG. 1 is a cross-sectional view showing an example of a solid state imaging module according to a first embodiment.

FIG. 2 is a cross-sectional view showing another example of the solid state imaging module according to the first embodiment.

FIG. 3 shows cross-sectional views for explaining solid state imaging modules having different optical arrangements.

FIG. 4 is a diagram showing an optical relationship among a main lens, a microlens array, and an imaging element.

FIG. 5 is a diagram showing the dependence of the reconstruction magnification ratio on the subject distance.

FIG. 6 is a diagram showing the dependence of the imaging distance of a microlens array on the subject distance.

FIGS. 7(a) and 7(b) each show an optical relationship among a main lens, a microlens array, and an imaging element.

FIG. 8 is a flow chart showing a process of changing camera modules attached to the main body (information processing device).

FIG. 9 is a block diagram showing the solid state imaging device according to the first embodiment.

FIG. 10 is a diagram showing the solid state imaging device according to the first embodiment.

FIGS. 11(a) and 11(b) are diagrams showing a solid state imaging device according to a second embodiment.

FIGS. 12(a) and 12(b) are diagrams showing a solid state imaging device according to a third embodiment.

FIGS. 13(a) and 13(b) are diagrams showing a solid state imaging device according to a fourth embodiment. FIGS. 14(a) and 14(b) are diagrams showing a solid state imaging device according to a fifth embodiment.

FIGS. 15(a) and 15(b) are diagrams showing a solid state imaging device according to a sixth embodiment.

### DETAILED DESCRIPTION

A solid state imaging module according to an embodiment can be attached to and detached from an information processing device, the solid state imaging module including: an imaging element formed on a semiconductor substrate and including a plurality of pixel blocks, each of the plurality of pixel blocks having a plurality of pixels; a first optical system for imaging a subject on an imaging plane; and input and output terminals that are connectable to the information processing device, which processes information from the imaging element.

It could be understood that a light field camera can be obtained by extending the function of the diaphragm mechanism in an ordinary camera. In an optical sense, a light field camera is formed of a multiple lens camera. With a light field camera, it is possible to photograph a plurality of images simultaneously, each image with a different angle of view and a different focal point. By analyzing the image data of such images, it is possible to generate an image that is in focus over the entire area. Furthermore, with a light field camera, it is possible to measure a distance using the depth of field, or estimate the direction of light source by the image data analysis. Thus, it is possible to obtain information that cannot be obtained with a conventional camera.

In view of this, a compound-eye imaging device that has an imaging lens capable of obtaining a large number of parallax images with a plurality of lenses, and restraining a decrease in resolution has been suggested. Such an imaging device includes an imaging lens, a microlens array onto which light passing through the imaging lens is incident, and an imaging element for receiving the light outputted from the microlens array. The focal length of each of the microlenses forming the microlens array is variable depending on the voltage to be applied thereto.

A liquid crystal lens is obtained by sealing liquid crystal in a lens-shaped space. By adjusting a voltage to be applied to the liquid crystal, the apparent refractive index of the liquid crystal is changed. Even if the shape of the lens is unchanged, if the refractive index of the liquid crystal changes, the focal length of the lens changes. However, if a liquid crystal lens is used as a variable focal point lens, a specific material has to be chosen to obtain a desired refractive index. The sealing of such a specific material would require a complicated structure, resulting in an increase in manufacturing costs. Furthermore, a liquid crystal lens is easily influenced by an environmental temperature. As a result, there is a possibility that the focal length of a liquid crystal lens may change in accordance with a change in environment temperature. Moreover, it is difficult to perform high-speed tracking in changing the focal point.

Embodiments will now be explained with reference to the accompanying diagrams.

In each of the solid state imaging devices of the embodiments described below, the switching between an ordinary high-definition imaging mode and an imaging mode based on the light field photography technology can be performed. Thus, a user can select between a solid state imaging module equipped with a microlens array and a solid state imaging module not equipped with a microlens array in accordance with the selected imaging mode. Furthermore, in the solid state imaging module equipped with a microlens array, optimum refocusing characteristic and distance measuring resolution can be obtained by using a different optical arrangement of the main lens and the microlens array depending on the subject distance.

### FIRST EMBODIMENT

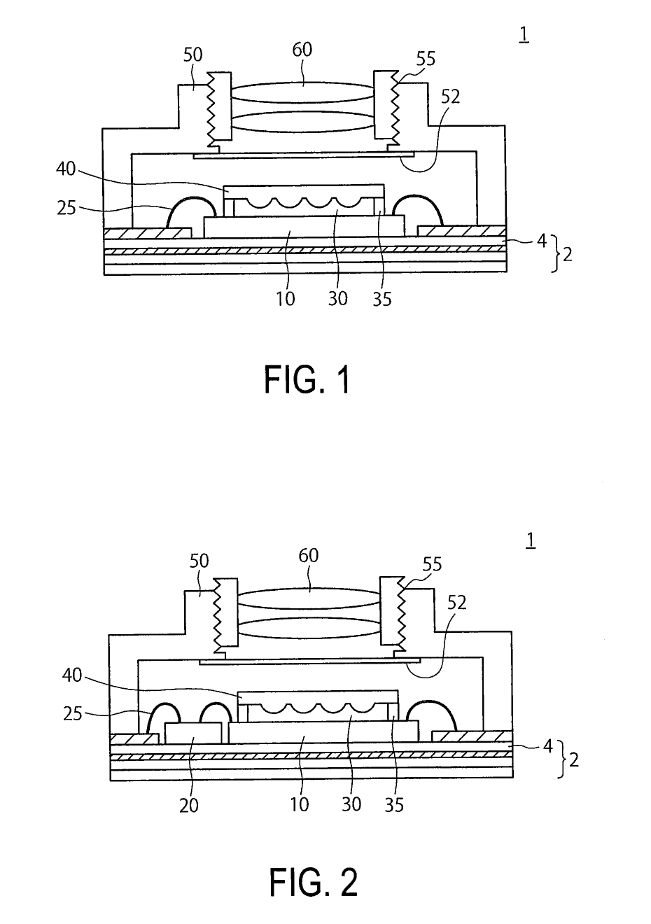

FIG. 1 shows a cross-sectional view of a solid state imaging module 1 used in a solid state imaging device according to a first embodiment. In the solid state imaging module according to the first embodiment, an imaging element (hereinafter also referred to as “sensor”) 10 includes a pixel array, in which photodiodes to serve as pixels (not shown) are arranged to form an array, on a semiconductor substrate 4 of a mount board 2, and a drive and readout circuit (not shown). The imaging element 10 is mounted on the mount board 2. The mount board 2 is, for example, a printed circuit board. Electrodes (not shown) are formed on the imaging element 10, which are connected to a chip such as a driving and processing chip via a bonding wire 25. As in another example shown in FIG. 2, an image processing LSI chip (ISP (Image Signal Processor)) 20 can be mounted together with the imaging element 10 on the same mount board 2. Another configuration can also be employed, in which under an electrode pad for reading pixels, which is not shown in the diagram, a through-electrode (not shown) is formed and connected to a chip such as a driving chip and a processing chip via a bump (not shown).

Above the pixels, a microlens array (hereinafter also referred to as “MLA”) 40 is arranged to face the pixel array of the imaging element 10. The microlens array 40 can be formed by, for example, processing a quartz substrate to have a lens shape. Alternatively, an element obtained by bonding a quartz substrate or a transparent substrate such as a glass substrate and a microlens array formed of a resin can also be used as the microlens array 40. The bonding of the microlens array 40 and the imaging element 10 is performed by using, for example, a bonding layer 35. The bonding layer 35 is formed of a thermoset resin, UV curable resin, or the like having a predetermined thickness and width, by such techniques as dispensing technique, screen printing technique, photolithography technique, etc. Since the microlens array 40 and the imaging element 10 are bonded via the bonding layer 35, a hole layer 30 is formed therebetween. The hole layer 30 is formed of the atmosphere. The distance between the microlens array 40 and the imaging element 10 determined by the hole layer 30 defines the imaging distance of the microlens array 40.

Above the microlens array 40, a visible light transparent substrate (IRCF (Infrared Cut Filter)) 52 is provided. The IRCF 52 can be formed of a material cutting unnecessary infrared rays, or a film for cutting infrared rays can be formed on the IRCF 52. The IRCF 52 is supported by, for example, a camera body 50, to which a main lens 60 for forming an image is provided. The main lens 60 is bonded with the camera body 50 by a bonding layer 55. In this embodiment, in the imaging mode based on the light field photography technology, the microlens array 40 is arranged between the main lens 60 and the imaging element 10. The main lens 60 and the visible light transparent substrate 52 form a first optical system, and the microlens array 40 forms a second optical system.

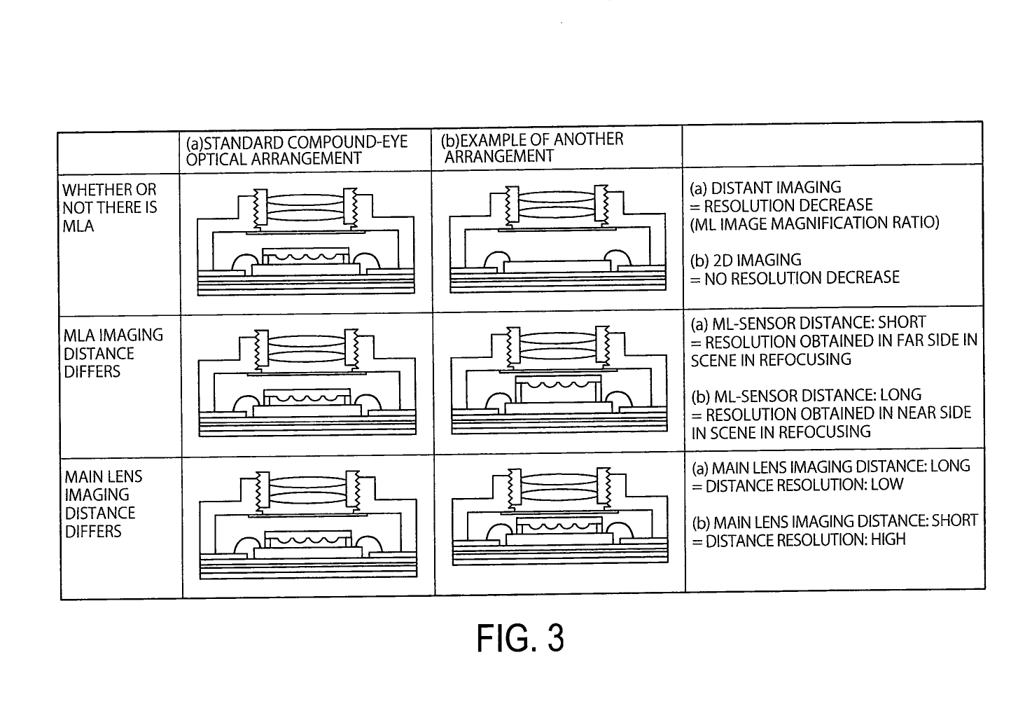

FIG. 3 shows examples of solid state imaging module, in which the optical arrangement differs from each other. The solid state imaging modules shown in FIG. 3 differ from each other in terms of the existence/absence of microlens array (MLA), the distance between the main lens and the imaging element (sensor), and the distance between the microlens array and the imaging element, have different characteristics.

First, attention is given to whether there is the microlens array 40 between the main lens 60 and the imaging element 10 or not. When there is no microlens array 40, the resolution of the solid state imaging module is not reduced, and imaging of a subject with a high definition by an ordinary imaging mode can be performed. When there is no microlens array 40, the solid state imaging module includes the imaging element 10 having a plurality of pixels, and the first optical system (main lens 60, IRCF 52) for forming an image of the subject on the pixels of the imaging element 10.

On the other hand, when there is the microlens array 40 between the main lens 60 and the imaging element 10 of the solid state imaging module, although the resolution is reduced, distance measuring can be performed, resulting in that the imaging mode based on the light field photography technology can be used. The solid state imaging module including the microlens array 40 has the imaging element 10 having a plurality of pixel blocks each having a plurality of pixels, the first optical system (main lens 60, IRCF 52) for forming an image of the subject on an imaging plane, the microlens array 40 having a plurality of microlenses corresponding to the pixel blocks, and the second optical system (microlens array 40) for re-imaging the image formed on the imaging plane in the pixel blocks corresponding to the respective microlenses.

In the solid state imaging device according to this embodiment, the solid state imaging module can be attached to and detached from main body (hereinafter also referred to as “information processing device”) as a camera module, as will be described later. Thus, according to this embodiment, a camera module having the microlens array 40 between the main lens and the imaging element, and another camera module not having the microlens array 40 are prepared in advance, and one of the camera modules, which meets the imaging mode desired by a user, is attached to the main body of the solid state imaging device. Thus, it is possible to select a desired imaging mode.

In the case where the microlens array 40 is inserted between the main lens 60 and the imaging element 10, it is possible to improve the refocusing and reconstructing performance with respect to the subject distance by means of the distance between the microlens array 40 and the imaging element 10. When the distance between the microlens array 40 and the imaging element 10 is relatively short, the resolution is obtained in the far side in the scene at the time of refocusing, and that on the other hand, when the distance between the microlens array 40 and the imaging element 10 is relatively long, the resolution is obtained in the near side in the scene.

When the microlens array 40 is inserted, if the imaging distance of the main lens is long, the distance resolution becomes low, and If the imaging distance of the main lens is short, the distance resolution becomes high.

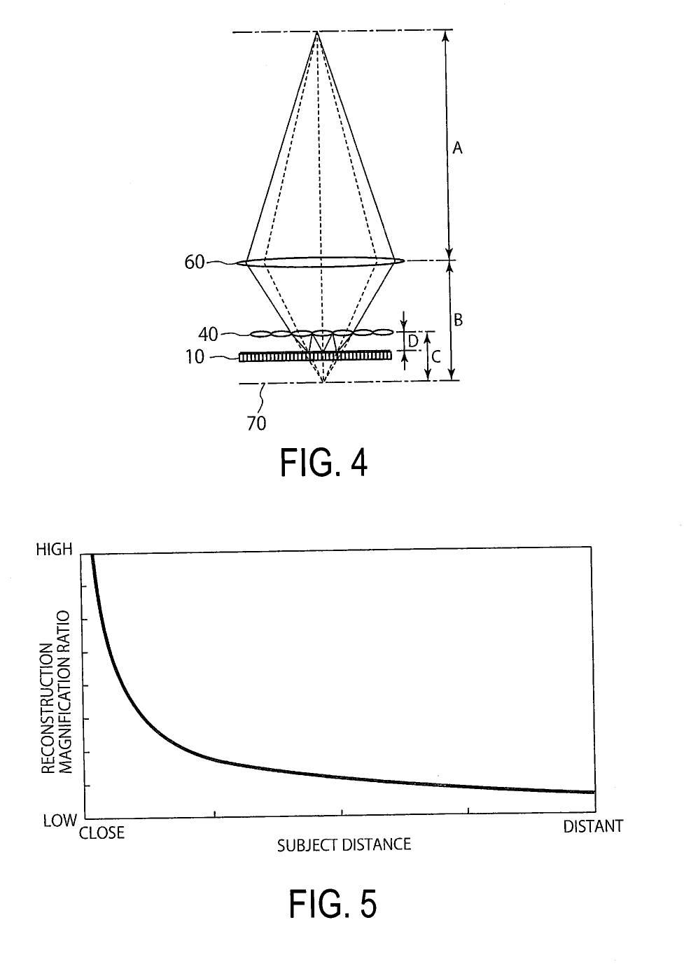

FIG. 4 shows the optical relationship among the main lens, the microlens array, and the imaging element. The refocusing processing will be described with reference to FIG. 4. As the subject distance A changes, the distance B from the main lens 60 to the main lens imaging plane 70 also changes.

Accordingly, the distance C between the main lens imaging plane 70 and the microlens array 40 changes, resulting in that the image magnification ratio N (=D/C) of the microlenses also changes, where D represents the distance from the microlens array 40 to the imaging element 10. If all the microlens images are magnified with a constant reconstruction magnification ratio 1/N throughout the scene, the image of a subject at the subject distance A is formed exactly at the portion of the imaging element 10, i.e., focused. On the other hand, the image of a subject at a subject distance A′ that is closer than or more distant than the subject distance A is formed slightly offset from the imaging element 10 and causes a blur, i.e., defocused. In order to refocus the respective images of the microlenses so as to be seen in the same manner as the image of the subject at the subject distance A, reconstruction processing is performed with a reconstruction magnification ratio (1/N) determined in accordance with the distance of each subject. For a subject located closer than the subject distance A, the reconstruction magnification ratio is high, and for a subject located more distant from the subject distance A, the reconstruction magnification ratio is low. The lower the reconstruction magnification ratio (1/N) is, the lower the ratio by which the image of a microlens 40 is reduced is low. Accordingly, the resolution of the reconstructed image is tend to be improved. FIG. 5 shows the relationship between the subject distance and the reconstruction magnification ratio.

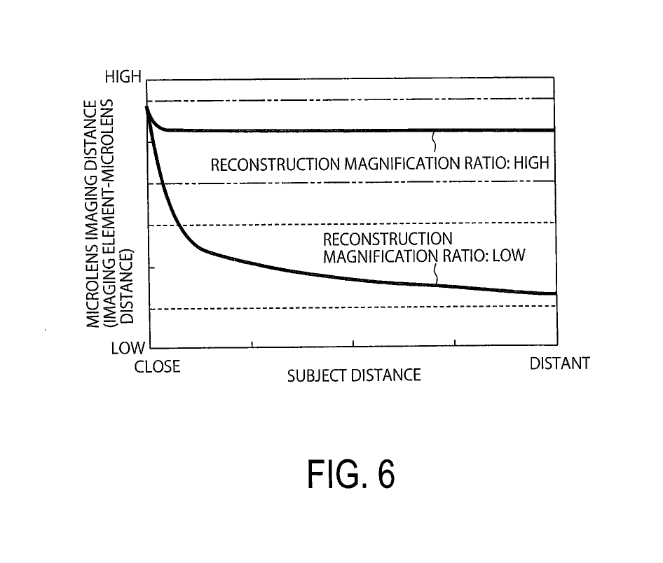

It has been described that the distance C changes depending on the subject distance A, resulting in that the image magnification ratio N (=D/C) of the microlenses 40 also changes. The range in which the focus can be obtained is determined by the microlens array Imaging distance D, i.e., the distance between the microlens array 40 and the imaging element 10. FIG. 6 shows the relationship between the subject distance A and the imaging distance D of the microlens array 40. As shown in FIG. 6, when the reconstruction magnification ratio is high, the microlens imaging distance is not dependent on the subject distance, but substantially constant, and when the reconstruction magnification ratio is low, the microlens imaging distance sharply decreases as the subject distance increases, and then gradually decreases from a certain point. It can be defined that when the sense of high resolution can be obtained in the near side in the scene, the bonding layer 35 of the microlens array 40 is thick, i.e., the imaging distance D is long, and when the sense of high resolution can be obtained in the far side in the scene, the bonding layer 35 is thin, i.e., the imaging distance D is short.

Therefore, according to this embodiment, a desired imaging mode can be selected by preparing preliminarily camera modules in which the distance between the microlens array 40 and the imaging element 10 differs from each other, and by changing the camera module attached to the imaging device main body according to the imaging mode desired by a user.

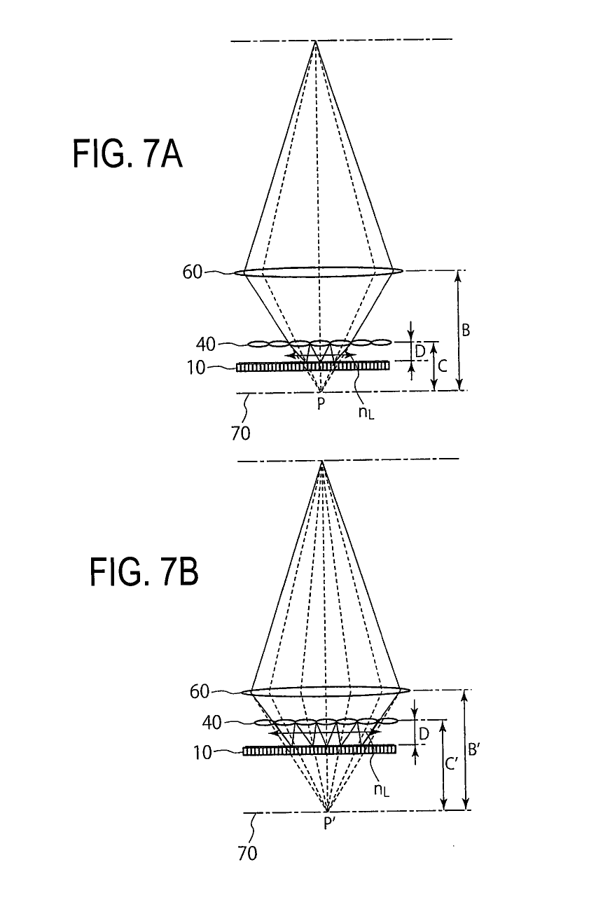

When the microlens array 40 is inserted between the main lens 60 and the imaging element 10 in the camera module, it is possible to improve the resolving power in the subject distance measurement based on the imaging distance of the main lens 60. Although the distance resolution is low when the imaging distance of the main lens 60 is long, the distance resolution can be improved by shortening the imaging distance of the main lens 60. Incidentally, the distance resolution and the resolution are in a trade-off relationship. FIGS. 7(a) and 7(b) show the optical relationship among the main lens 60, the microlens array 40, and imaging element 10. With reference to FIGS. 7(a) and 7(b), the distance resolution will be described. FIG. 7(a) shows the case where the imaging distance of the main lens 60 is long, and FIG. 7(b) shows the case where the imaging distance of the main lens 60 is short. In distance measurement based on the light field photography technology, the distance resolution is dependent on the base line length of the microlens array 40. The distance resolution can be represented by the following formula:

ΔC=(C²/Dn_{L})×Δd (1)

wherein ΔC denotes distance resolution, C denotes the distance between the microlens array 40 and the imaging plane 70 of the main lens 60, D denotes the distance between the microlens array 40 and the imaging element 10, denotes the base line length, and Δd denotes a minimum parallax that can be detected. Thus, the distance resolution ΔC is improved in proportion to 1/n_{L}. As shown in FIGS. 7(a) and 7(b), the base line length n_{L} increases as the sum of the distance between the main lens 60 and the imaging element 10 and the distance between the microlens array 40 and the imaging element 10 decreases, and decreases as the sum of the distance between the main lens 60 and the imaging element 10 and the distance between the microlens array 40 and the imaging element 10 increases.

In this optical system, the resolution is in proportion to D/C. Since C decreases as the sum of the distance between the main lens 60 and the imaging element 10 and the distance between the microlens array 40 and the imaging element 10 decreases, the resolution is improved. In contrast, as shown in FIG. 7(b), since C′ increases as the sum of the distance between the main lens 60 and the imaging element 10 and the distance between the microlens array 40 and the imaging element 10 increases, the resolution is lowered. Thus, the distance resolution and the resolution are in the trade-off relationship.

Therefore, according to this embodiment, a desired imaging mode can be selected by preparing preliminarily camera modules in which the imaging distance B of the main lens 60 differs from each other, and by changing the camera module attached to the imaging device main body according to the imaging mode desired by a user. Alternatively, a desired imaging mode can be selected by preparing preliminary camera modules in which whether or not there is a microlens array, the distance between the main lens 60 and the imaging element 10, and the distance between the microlens array 40 and the imaging element 10 differ from each other, and by changing the camera module attached to the imaging device main body according to the imaging mode desired by a user.

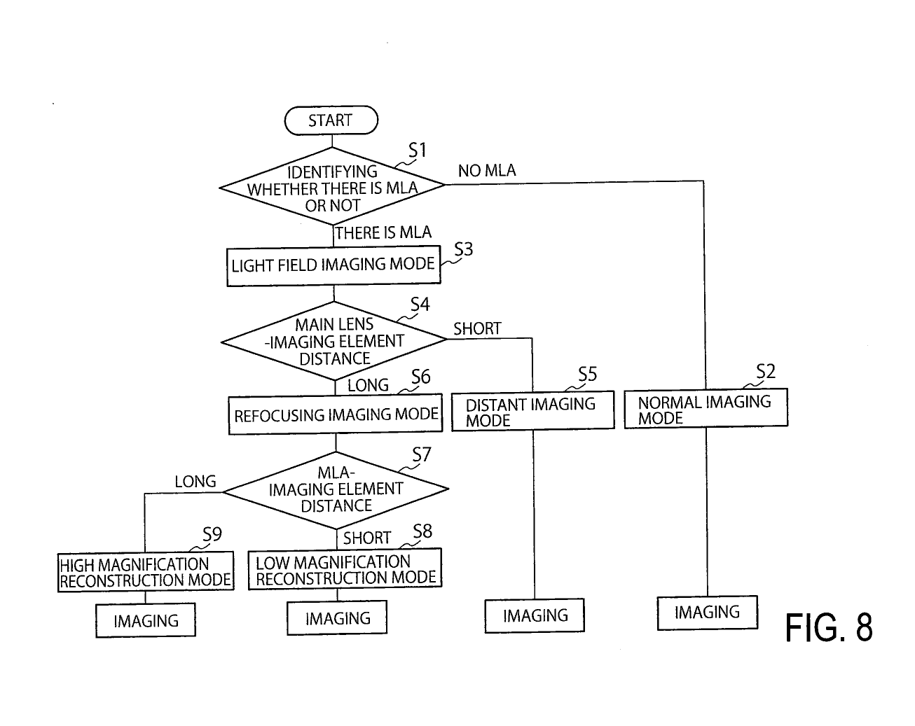

FIG. 8 is a flow chart showing the process of identifying the optical arrangement of a camera module to perform predetermined processing in a solid state imaging device, to the main body of which one of camera modules each having a different optical arrangement can be attached. The solid state imaging device has a memory unit that preliminarily stores the optical arrangements. When the solid state imaging device is electrically or mechanically connected to the main body of the connection unit, first, whether or not there is a microlens array 40 is determined in the solid state imaging device (step S1). If it is determined that there is no microlens array 40, the normal imaging mode is activated (step S2).

When it is determined that there is a microlens array 40, the light field imaging mode is activated (step S3). After the light field imaging mode is activated, the distance between the main lens 60 and the imaging element 10 is determined (step S4). If it is determined that a high distance resolution is required, i.e., the distance is short, the distant imaging mode is activated (step S5). If it is determined the refocusing imaging mode is required, i.e., the aforementioned distance is long (step S6), the distance between the microlens array 40 and the imaging element 10 is determined (step S7). If this distance is short, the low magnification reconstruction mode is activated (step S8). If this distance is long, the high magnification reconstruction mode is activated (step S9).

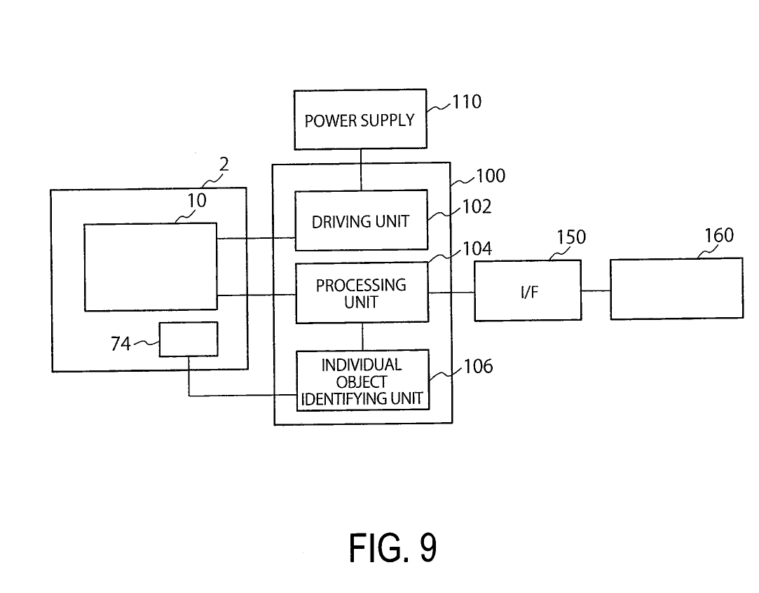

FIG. 9 shows a block diagram of the solid state imaging device of this embodiment, in which the camera module can be selected from a plurality of different camera modules each having a different optical arrangement. It is desirable that the memory unit storing the optical arrangement is a nonvolatile memory. According to FIG. 9, the imaging element 10 is mounted on the mount board 2, and a memory unit 74 is mounted on the mount board 2, the memory unit 74 storing identification data for identifying the solid state imaging module 1 and optical arrangement data of the solid state imaging module 1, and electrically connecting to systems 102, 104, 106 formed on a circuit board 100 provided in the later stage. The main body (information processing device) including the sircuit board 100 and systems 102, 104, 106. The optical arrangement data stored in the memory unit 74 are optical data required for processing output signals from the solid state imaging module 1, for example, whether or not there is a microlens array 40 (whether or not there is an object between the main lens 60 and the imaging element 10), the distance B between the main lens 60 and the main lens imaging plane 70, the distance C between the main lens imaging plane 70 and the microlens array 40, and the distance D between the microlens array 40 and the imaging element 10. The memory unit 74 can be formed within the solid state imaging module 1. The mount board 2 is electrically connected to the circuit board 100, on which a driving unit 102 for driving the imaging element 10, a processing unit 104 for processing output signals from the imaging element 10, and an individual object identifying unit 106 for identifying the solid state imaging module attached using the data stored in the memory unit 74 in a manner shown in FIG. 8. The solid state imaging device also includes a power supply 110, etc. required for driving the imaging element 10. The processing unit 104 processes output signals from the solid state imaging module based on the result of the identification by the individual object identifying unit 106 and the optical arrangement data stored in the memory unit 74. A part or all of the functions for processing signals from the imaging element 10 can be implemented as an image processing LSI chip on the mount board 2, as shown in FIG. 2. The output signals from the imaging element 10 are outputted to an output device 160 via an interface 150. For example, the output device 160 is a display, etc.

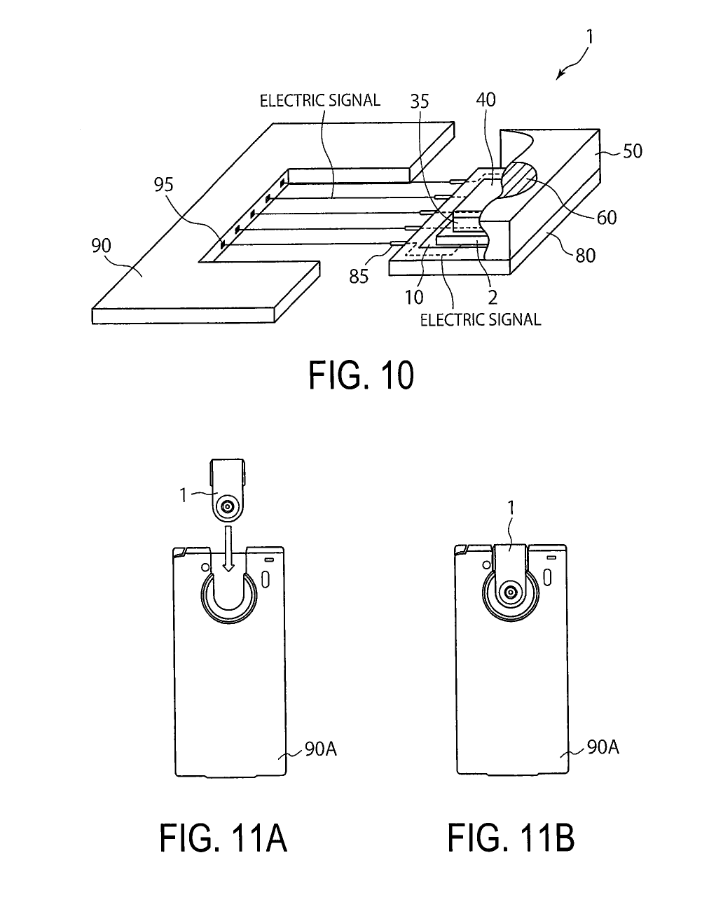

FIG. 10 shows the solid state imaging device according to this embodiment, in which the solid state imaging module 1 can be attached and detached. The solid state imaging device according to this embodiment includes the solid state imaging module 1 and the connection unit main body 90.

The solid state imaging module 1 is, for example, one of the solid state imaging modules shown in FIGS. 1 to 3, and can be mounted on a corresponding solid state imaging module mount substrate 80. A plurality of connector pins 85 are provided to the solid state imaging module mount substrate 80, which are connected to the input terminal and the output terminal of the solid state imaging module 1.

The connection unit main body 90 includes a connector unit 95, to which the connector pins 85 of the solid state imaging module 1 are inserted. When the connector pins 85 of the solid state imaging module 1 are inserted into the connector unit 95 of the connection unit main body 90, the solid state imaging module 1 and the connection unit main body 90 are electrically connected with each other. Besides the connector pins 85 and the connector unit 95 for the electrical connection, the solid state imaging device mount substrate 80 and the connection unit main body 90 may include another well-known mechanism for mechanical connection. Since each solid state imaging module has the connector pins 85 with the same shape and the same arrangement, even if a solid state imaging module is replaced with another, the electrical and mechanical connection of the replaced solid state imaging module can be ensured.

The circuit board 100 can be included in the connection unit main body 90. Furthermore, the interface 150 and the output device 160 can also be included in the connection unit main body. As described above, according to this embodiment, since there are a plurality of solid state imaging modules each having a different optical arrangement, and there is the connection unit main body 90 to which all of the solid state imaging modules can be connected, it is possible to select a solid state imaging module according to an imaging mode selected. As a result, it is possible to obtain a solid state imaging device that is inexpensive and highly reliable.

### SECOND EMBODIMENT

FIGS. 11(a) and 11(b) show a solid state imaging device according to a second embodiment, in which the connection unit main body 90 shown in FIG. 10 is a portable mobile communications terminal 90A. As in the first embodiment, one of a plurality of solid state imaging modules 1 each having a different optical arrangement can be connected to the portable mobile communications terminal 90A in the solid state imaging device of the second embodiment. FIG. 11(a) shows the state where one of the solid state imaging modules 1 is selected but it has not been attached yet, and FIG. 11(b) shows the state where the selected solid state imaging module 1 has been attached.

As in the first embodiment, in this second embodiment, it is possible to select a solid state imaging module according to an imaging mode selected, and it is possible to obtain a solid state imaging device that is inexpensive and highly reliable.

### THIRD EMBODIMENT

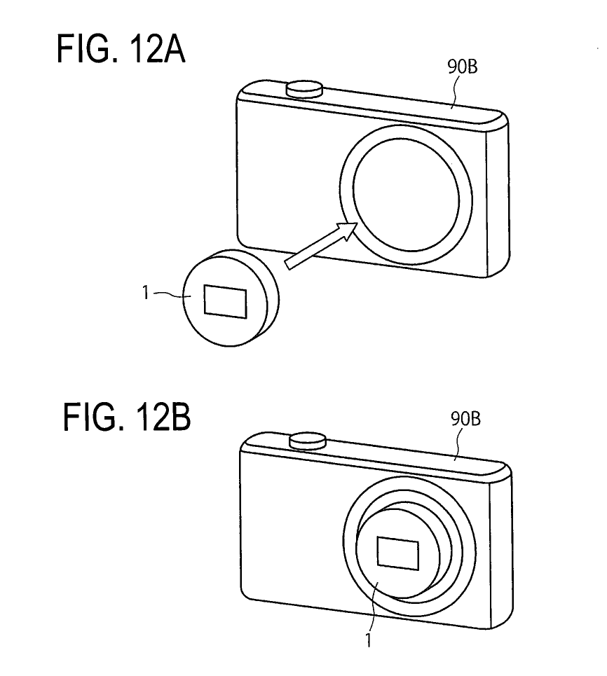

FIGS. 12(a) and 12(b) show a solid state imaging device according to a third embodiment, in which the connection unit main body 90 shown in FIG. 10 is a digital still camera 90B. As in the first embodiment, one of a plurality of solid state imaging modules 1 each having a different optical arrangement is selected in the solid state imaging device of the third embodiment. FIG. 12(a) shows the state where one of the solid state imaging modules 1 is selected but it has not been attached yet, and FIG. 12(b) shows the state where the selected solid state imaging module 1 has been attached.

As in the first embodiment, in this third embodiment, it is possible to select a solid state imaging module according to an imaging mode selected, and it is possible to obtain a solid state imaging device that is inexpensive and highly reliable.

### FOURTH EMBODIMENT

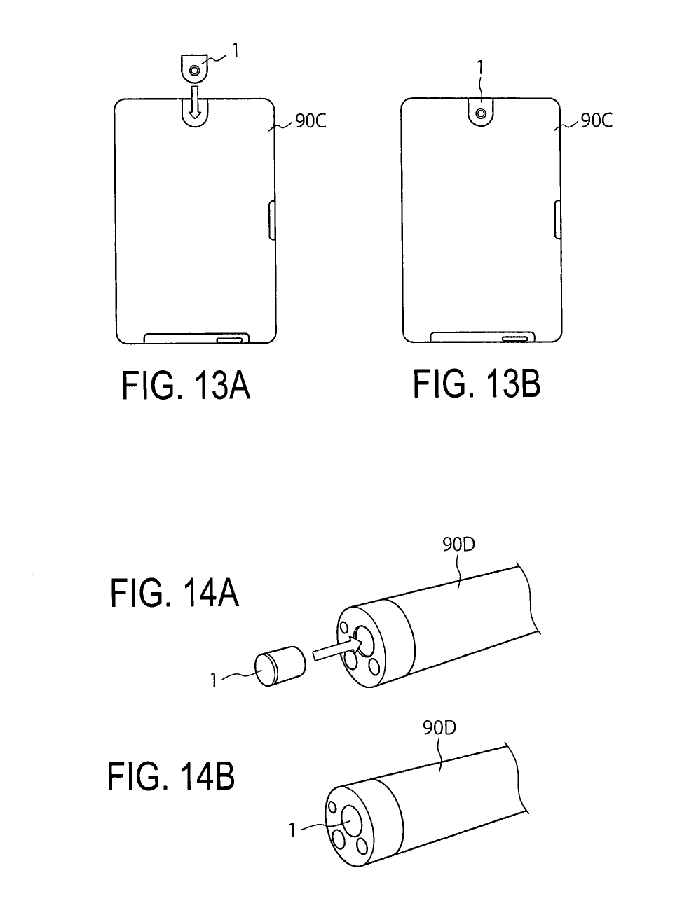

FIGS. 13(a) and 13(b) show a solid state imaging device according to a fourth embodiment, in which the connection unit main body 90 shown in FIG. 10 Is a tablet PC (personal computer) 90C. As in the first embodiment, one of a plurality of solid state imaging modules 1 each having a different optical arrangement is selected in the solid state imaging device of the fourth embodiment. FIG. 13(a) shows the state where one of the solid state imaging modules 1 is selected but it has not been attached yet, and FIG. 13(b) shows the state where the selected solid state imaging module 1 has been attached.

As in the first embodiment, in this fourth embodiment, it is possible to select a solid state imaging module according to an imaging mode selected, and it is possible to obtain a solid state imaging device that is inexpensive and highly reliable.

### FIFTH EMBODIMENT

FIGS. 14(a) and 14(b) show a solid state imaging device according to a fifth embodiment, in which the connection unit main body 90 shown in FIG. 10 is an endoscope 90D. As in the first embodiment, one of a plurality of solid state imaging modules 1 each having a different optical arrangement is selected in the solid state imaging device of the fifth embodiment. FIG. 14(a) shows the state where one of the solid state imaging modules 1 is selected but it has not been attached yet, and FIG. 14(b) shows the state where the selected solid state imaging module 1 has been attached.

As in the first embodiment, in this fifth embodiment, it is possible to select a solid state imaging module according to an imaging mode selected, and it is possible to obtain a solid state imaging device that is inexpensive and highly reliable.

### SIXTH EMBODIMENT

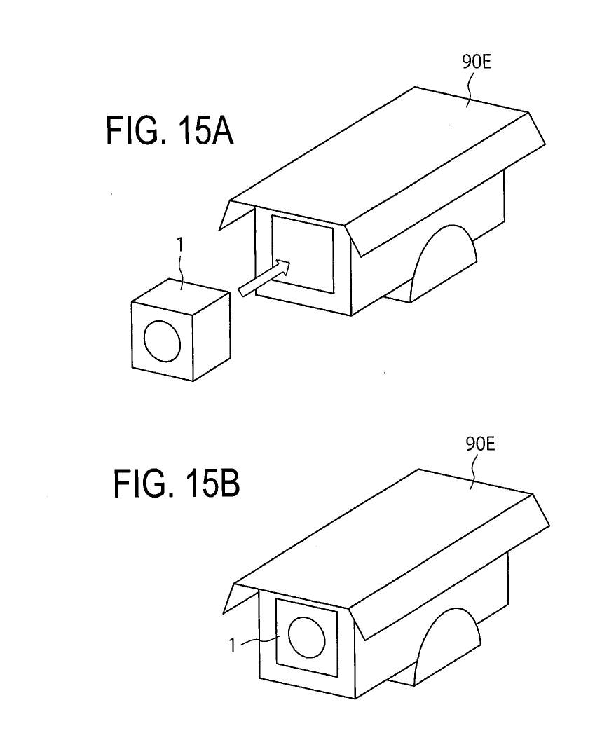

FIGS. 15(a) and 15(b) show a solid state imaging device according to a sixth embodiment, in which the connection unit main body 90 shown in FIG. 10 is a security camera 90E. As in the first embodiment, one of a plurality of solid state imaging modules 1 each having a different optical arrangement is selected in the solid state imaging device of the fifth embodiment. FIG. 15(a) shows the state where one of the solid state imaging modules 1 is selected but it has not been attached yet, and FIG. 15(b) shows the state where the selected solid state imaging module 1 has been attached.

As in the first embodiment, in this sixth embodiment, it is possible to select a solid state imaging module according to an imaging mode selected, and it is possible to obtain a solid state imaging device that is inexpensive and highly reliable.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A solid state imaging module that can be attached to and detached from an information processing device, the solid state imaging module comprising:
an imaging element formed on a semiconductor substrate and including a plurality of pixel blocks, each of the plurality of pixel blocks having a plurality of pixels;
a first optical system for imaging a subject on an imaging plane; and
input and output terminals that are connectable to the information processing device, which processes information from the imaging element.

2. The module according to claim 1, further comprising a second optical system including a microlens array having a plurality of microlenses corresponding to the pixel blocks.

3. The module according to claim 2, wherein in the second optical system, the microlenses re-image an image formed on the imaging plane in the corresponding pixel blocks.

4. The module according to claim 1, further comprising a memory for storing at least one of identification information items of whether there is an object between the first optical system and the imaging element, and a distance from the first optical system to the imaging plane.

5. The module according to claim 2, further comprising a memory for storing at least one of identification information items of whether there is an object between the first optical system and the imaging element, a distance from the first optical system to the imaging plane, a distance from the imaging plane to the second optical system, and a distance from the second optical system to the imaging element.

6. A solid state imaging device comprising:
the solid state imaging module according to claim 4; and
an information processing device having terminals electrically connected to the input and output terminals of the solid state imaging module, the information processing device having an identification unit for identifying the solid state imaging module based on the identification item stored in the memory, and a processing unit for processing output signals from the solid state imaging module based on a result of identification by the identification unit and the identification information item stored in the memory.

7. The device according to claim 6, wherein the information processing device is a portable mobile communications terminal.

8. The device according to claim 6, wherein the information processing device is a digital still camera.

9. The device according to claim 6, wherein the information processing device is a tablet personal computer.

10. The according to claim 6, wherein the information processing device is an endoscope.

11. The device according to claim 6, wherein the information processing device is a security camera.

12. An information processing device, in which the solid state imaging module according to claim 4 can be attached and detached, the information processing device comprising:
terminals electrically connectable to the input and output terminal of the solid state imaging module;
an identification unit for identifying the solid state imaging module, in a state where the solid state imaging module is attached, based on the identification information item stored in the memory; and
a processing unit for processing an output signal from the solid state imaging module based on a result of identification by the identification unit and the identification information item stored in the memory.
